(19) United States
(12) Patent Application Publication
(10) Pub. No.: US 2014/0337065 A1
(43) Pub. Date: Nov. 13, 2014

(54) INFORMATION PROCESSING DEVICE, INFORMATION PROCESSING METHOD, AND PROGRAM FOR INFORMATION PROCESSING DEVICE

(71) Applicant: RAKUTEN, INC., Shinagawa-ku, Tokyo (JP)

(72) Inventors: Yuji Suzuki, Shinagawa-ku (JP); Takao Oyobe, Shinagawa-ku (JP); Takaaki Koshinuma, Shinagawa-ku (JP); Katsuyuki Masubuchi, Shinagawa-ku (JP)

(73) Assignee: RAKUTEN, INC., Shinagawa-ku, Tokyo (JP)

(21) Appl. No.: 14/359,835

(22) PCT Filed: Apr. 3, 2013
(86) PCT No.: PCT/JP2013/060184

§ 371 Date: May 21, 2014

(30) Foreign Application Priority Data
Sep. 26, 2012 (JP) 2012-212752

(51) Int. Cl. G06Q 10/02; G06F 17/30

(52) U.S. Cl. CPC G06Q 10/02; G06F 17/30864
USPC 705/5

(57) ABSTRACT

Vacant seat information for specifying the number of vacant seats in a store and store identification information for identifying the store are acquired from a mobile terminal device of a user of the store. The vacant seat information is registered in a storage in association with the store identification information. A search condition including the number of members is acquired from a terminal device of a user who looks for a target store to use. The vacant seat information and the store identification information registered in the storage are collated with the acquired search condition. The collation results are transmitted to the terminal device.

### TECHNICAL FIELD

The present invention relates to the technical field of an information processing device, an information processing method, and a program for the information processing device for providing information on vacant seats of a store.

### BACKGROUND ART

A system which receives a search condition from a user who searches for stores having vacant seats and transmits information on stores and information on vacant seats registered by the stores to the user is known. For example, Patent Document 1 discloses a vacant seat information providing system which registers vacant seat information and a registration time of the vacant seat information in a facility database when the vacant seat information is received from a facility terminal of a store or the like, receives conditions from the terminal, extracts information on a facility meeting the conditions, the vacant seat information, and the registration time of the vacant seat information, and transmits the same.

### CITATION LIST

### Patent Document

Patent Document 1: JP 2003-76902 A

### SUMMARY OF THE INVENTION

### Problem to be Solved by the Invention

However, since such a conventional technique as Patent Document 1 requires a vacant seat registration operation to be performed by a staff of a store, the registration operation incurs the time and labor of the store's staff.

With the foregoing in view, an example of the object of the present invention is to reduce the time and labor of the store's staff required for the vacant seat registration operation.

### Means for Solving the Problem

In order to solve the above problem, the invention described in claim 1 includes an information acquiring means that acquires vacant seat information for specifying the number of vacant seats in a store and store identification information for identifying the store from a mobile terminal device of a user of the store; a registering means that registers the vacant seat information in a storing means in association with the store identification information; a search condition acquiring means that acquires a search condition including the number of members from a terminal device of a user who looks for a target store to use; a collating means that collates the vacant seat information and the store identification information registered in the storing means with the search condition acquired by the search condition acquiring means; and a collation result transmitting means that transmits collation results obtained by the collating means to the terminal device.

Therefore, by collating the vacant seat information and the store information registered from the mobile terminal device of the user of the store with the search condition acquired from the terminal device of the user who looks for a target store to use, it is possible to reduce the time and labor of a store's staff required for the vacant seat registration operation.

In the information processing device described in claim 1, the invention described in claim 2 is characterized in that the information acquiring means acquires registration determination information for determining whether the vacant seat information is to be registered in the storing means from the mobile terminal device, the information processing device further includes a registration reception determining means that determines whether the registration of the vacant seat information in the storing means is to be received or not according to the registration determination information acquired by the information acquiring means, and the registering means registers the vacant seat information in association with the store identification information when the registration reception determining means determines that the registration is to be received.

In this case, the registration determination information is acquired from the mobile terminal device, and it is determined whether the information is to be registered based on the registration determination information. The information is registered when it is determined that the information is to be registered. Thus, it is possible to eliminate the registration of vacant seat information that is not suitable for registration.

In the information processing device described in claim 2, the invention described in claim 3 is characterized in that the registration reception determining means determines whether the registration of the vacant seat information is to be received based on a distance between the mobile terminal device and the store.

In this case, since it is determined whether the registration of the vacant seat information is to be received based on the distance between the mobile terminal device and the store, it is possible to eliminate the registration of the vacant seat information that is not suitable for registration for example since the mobile terminal device is away from the store.

In the information processing device described in any one of claims 1 to 3, the invention described in claim 4 is characterized in that when the vacant seat information of the same content is acquired from the mobile terminal device within a first predetermined time, the registration reception determining means determines that the registration of the vacant seat information is not to be received.

In this case, it is possible to prevent unnecessary registration of the redundant vacant seat information from the same mobile terminal device. Moreover, it is possible to eliminate an unnecessary privilege from being provided.

In the information processing device described in any one of claims 1 to 4, the invention described in claim 5 is characterized in that the information processing device further includes: a matching privilege determining means that determines a privilege provided to the user of the mobile terminal device when the terminal device accesses a webpage showing the vacant seat information of a specific store, acquired from the mobile terminal device after the collating means performs the collation.

In this case, it is possible to provide an incentive to register the vacant seat information.

In the information processing device described in any one of claims 2 to 5, the invention described in claim 6 is characterized in that the information processing device further includes: a registration privilege determining means that determines a privilege provided to the user of the mobile terminal device when the registration reception determining means determines that the registration of the vacant seat information is to be received.

In this case, by providing the privilege to the registrant, it is possible to provide an incentive to register the vacant seat information.

In the information processing device described in claim 5 or 6, the invention described in claim 7 is characterized in that at least one of the matching privilege determining means and the registration privilege determining means changes the value of the provided privilege according to a time zone.

In this case, by increasing the provided privilege in a time zone when the user of the terminal device wants to have information, it is possible to increase the incentive to register the vacant seat information.

In the information processing device described in claim 7, the invention described in claim 8 is characterized in that at least one of the matching privilege determining means and the registration privilege determining means increases the value of the provided privilege in a time zone when many persons actually use the store.

In this case, for example, since the information when many persons actually use the store and the store is congested is information that the user of the terminal device wants to have, by increasing the value of the provided privilege in a time zone when the store is congested, it is possible to increase the incentive for the registration.

In the information processing device described in any one of claims 5 to 8, the invention described in claim 9 is characterized in that when the information acquiring means acquires the vacant seat information of the same content from the mobile terminal devices of a plurality of store users within a second predetermined time, at least one of the matching privilege determining means and the registration privilege determining means determines the privilege according to the registration time of the vacant seat information.

In this case, by increasing the value of the privilege for early registration, for example, it is possible to provide an incentive to register the vacant seat information of the store as early as possible and to collect relatively new information.

In the information processing device described in claim 9, the invention described in claim 10 is characterized in that the information processing device further includes: a vacant seat information determining means that determines whether the vacant seat information is information on the same vacant seat when the information acquiring means acquires the vacant seat information of the same content from the mobile terminal devices of the plurality of store users within the second predetermined time, wherein at least one of the matching privilege determining means and the registration privilege determining means determines the privilege provided to the plurality of store users according to the registration time of the vacant seat information when the vacant seat information determining means determines that the vacant seat information is information on the same vacant seat.

In this case, by increasing the value of the privilege for the early registration, for example, it is possible to provide the incentive to register the vacant seat information of the same content as early as possible and to collect relatively new information.

In the information processing device described in any one of claims 1 to 10, the invention described in claim 11 is characterized in that the vacant seat information is the number of vacant seats.

In this case, it is possible to know the number of vacant seats in the store and to provide the user of the terminal device with the information on the number of vacant seats in the store.

In the information processing device described in any one of claims 1 to 10, the invention described in claim 12 is characterized in that the vacant seat information is information on a layout diagram indicating a layout of at least one of seats and tables in the store, which is displayed on the mobile terminal device and input by the user of the mobile terminal device.

In this case, it becomes easy to specify the positions of the seats or tables by the layout diagram and to input the vacant seat information. With the layout diagram, it is possible to know the position of the vacant seat and to input the accurate vacant seat information.

The invention described in claim 12 is characterized in that an information processing method of an information processing device that performs information processing includes: an information acquiring step of acquiring vacant seat information for specifying the number of vacant seats in a store and store identification information for identifying the store from a mobile terminal device of a user of the store; a registering step of registering the vacant seat information in a storing means in association with the store identification information; a search condition acquiring step of acquiring a search condition including the number of members from a terminal device of a user who looks for a target store to use; a collating step of collating the vacant seat information and the store identification information registered in the storing means with the search condition acquired in the search condition acquiring step; and a collation result transmitting step of transmitting collation results obtained by the collating means to the terminal device.

The invention described in claim 13 causes a computer to function as: an information acquiring means that acquires vacant seat information for specifying the number of vacant seats in a store and store identification information for identifying the store from a mobile terminal device of a user of the store; a registering means that registers the vacant seat information in a storing means in association with the store identification information; a search condition acquiring means that acquires a search condition including the number of members from a terminal device of a user who looks for a target store to use; a collating means that collates the vacant seat information and the store identification information registered in the storing means with the search condition acquired by the search condition acquiring means; and a collation result transmitting means that transmits collation results obtained by the collating means to the terminal device.

### Effect of the Invention

According to the present invention, by collating the vacant seat information and the store identification information registered from the mobile terminal device of the user of the store with the search condition acquired from the terminal device of the user who looks for a target store to use, it is possible to reduce the time and labor of a store's staff required for the vacant seat registration operation.

### BRIEF DESCRIPTION OF THE DRAWINGS

FIG. 1 is a schematic diagram illustrating an example of a schematic configuration of an information processing system according to an embodiment of the present invention.

FIG. 2 is a block diagram illustrating an example of a schematic configuration of an information processing server of FIG. 1.

FIG. 3 is a schematic view illustrating an example of data stored in a store database of FIG. 2.

FIG. 4 is a schematic diagram illustrating an example of data stored in registration determination database of FIG. 2.

FIG. 5 is a schematic diagram illustrating an example of data stored in a vacant seat information database of FIG. 2.

FIG. 6 is a block diagram illustrating an example of a schematic configuration of a mobile terminal device of FIG. 1.

FIG. 7 is a block diagram illustrating an example of a schematic configuration of a terminal device of FIG. 1.

FIG. 8 is a schematic diagram illustrating an example of a screen for registering vacant seat information.

FIG. 9 is a schematic diagram illustrating an example of a screen for inputting vacant seat information.

FIG. 10 is a flowchart illustrating an example of an operation of the information processing server of FIG. 1.

FIG. 11 is a schematic diagram illustrating an example of retrieval results obtained by the information processing server of FIG. 1.

FIG. 12 is a schematic diagram illustrating an example of a screen for displaying vacant seat information.

### MODE FOR CARRYING OUT THE INVENTION

Hereinafter, an embodiment of the present invention will be described in detail with reference to the drawings. The embodiment described below is an embodiment when the present invention is applied to information processing system.

[1. Overview of Configuration and Function of Information Processing System]

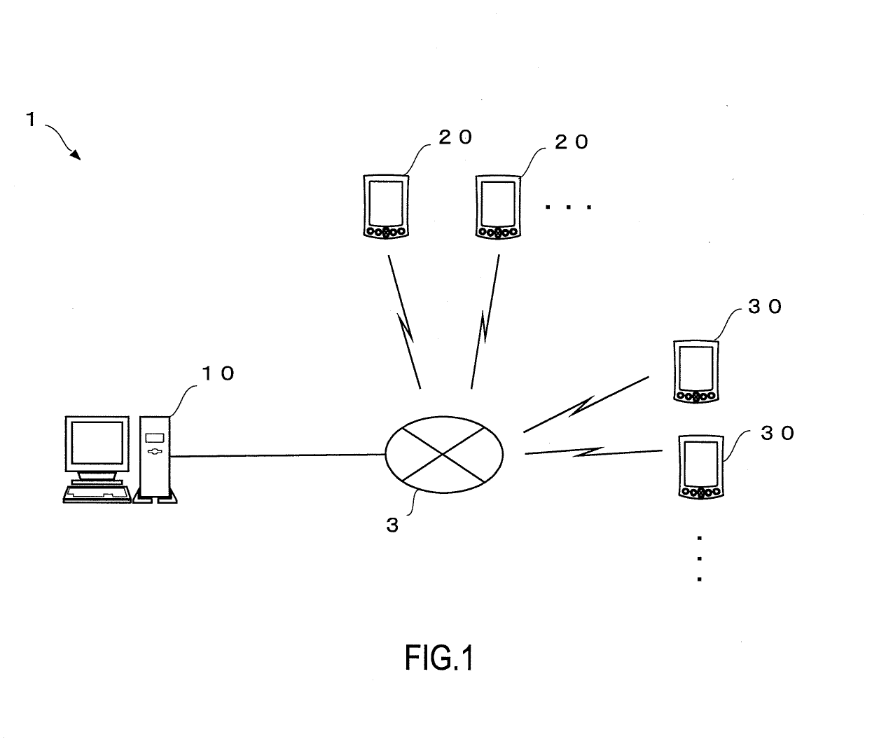

First, an overview of the configuration and function of an information processing system according to the present embodiment will be described with reference to FIG. 1.

FIG. 1 is a schematic diagram illustrating an example of a schematic configuration of an information processing system 1 according to the present embodiment.

As illustrated in FIG. 1, the information processing system 1 includes an information processing server 10 (an example of an information processing device) that relays vacant seat information for specifying the number of vacant seats in stores between users of store, a mobile terminal device 20 (an example of a mobile terminal device) for allowing a user (store user) who uses or has used the store to register vacant seat information, and a terminal device 30 (an example of a terminal device) of a user who searches for a target store to use.

The information processing server 10, the mobile terminal device 20, and the terminal device 30 can transmit and receive data to and from each other via a network 3 by using, for example, TCP/IP or the like as a communication protocol. Incidentally, the network 3 is constructed by, for example, the Internet, a dedicated communication line (for example, a community antenna television (CATV) line), a mobile communication network (including a base station and the like), a gateway, or the like.

The information processing server 10 receives the registration of the vacant seat information from the mobile terminal device 20 and receives the search condition for stores and vacant seats from the terminal device 30. The information processing server 10 collates the registered vacant seat information with the search condition and transmits collation results. Moreover, after collating the vacant seat information with the search condition, the information processing server 10 transmits information on a webpage indicating the vacant seat information of a specific store and receives a reservation for a store. In this manner, the information processing server 10 provides a matching site. Moreover, the information processing server 10 provides a portal site that handles store information of a store like a restaurant.

The mobile terminal device 20 is a mobile terminal having the function of a computer. The user (registrant) of the mobile terminal device 20 registers the vacant seat information of the store that the user uses or has used from a webpage or the like of the store.

The terminal device 30 is a mobile terminal having the function of a computer. The user of the terminal device 30 searches for and finds a target store to use. The terminal device 30 searches for a store having vacant seats in a webpage search webpage or the like provided by the information processing server 10 and receives retrieval results.

[2. Configuration and Function of Information Processing Server and Respective Terminal Devices]

(2.1 Configuration and Function of Information Processing Server 10)

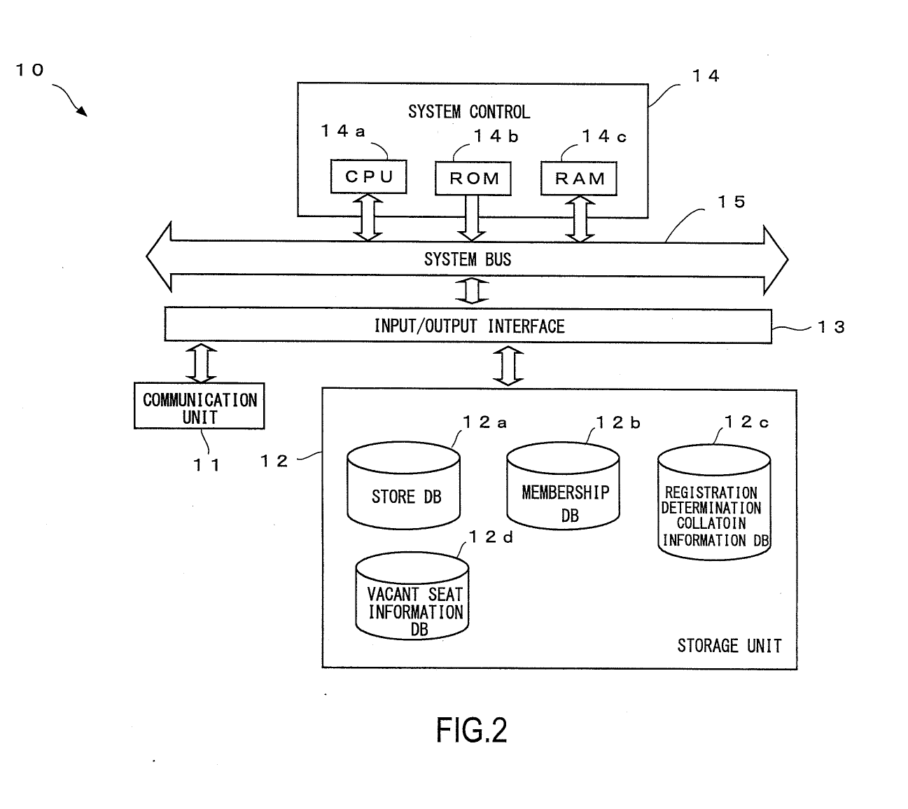

Next, the configuration and function of the information processing server 10 will be described with reference to FIGS. 2 to 5.

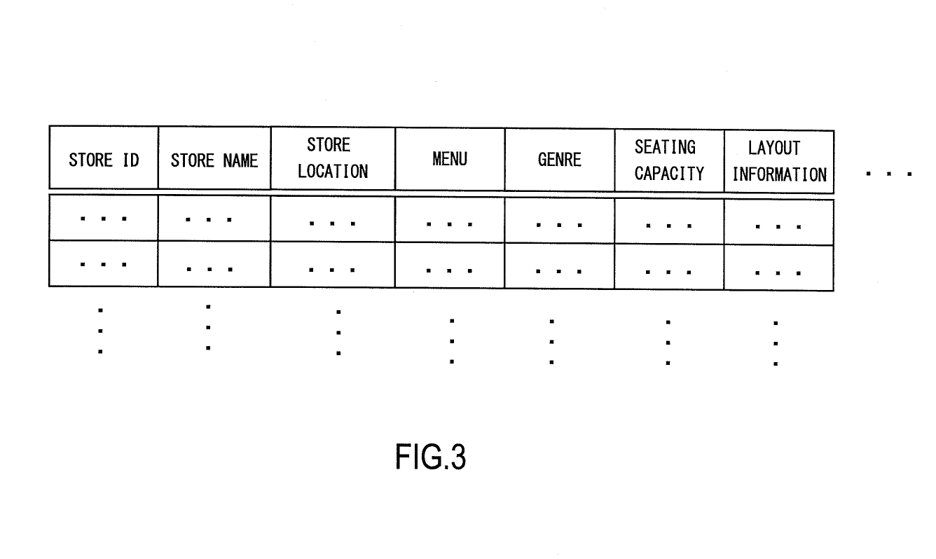

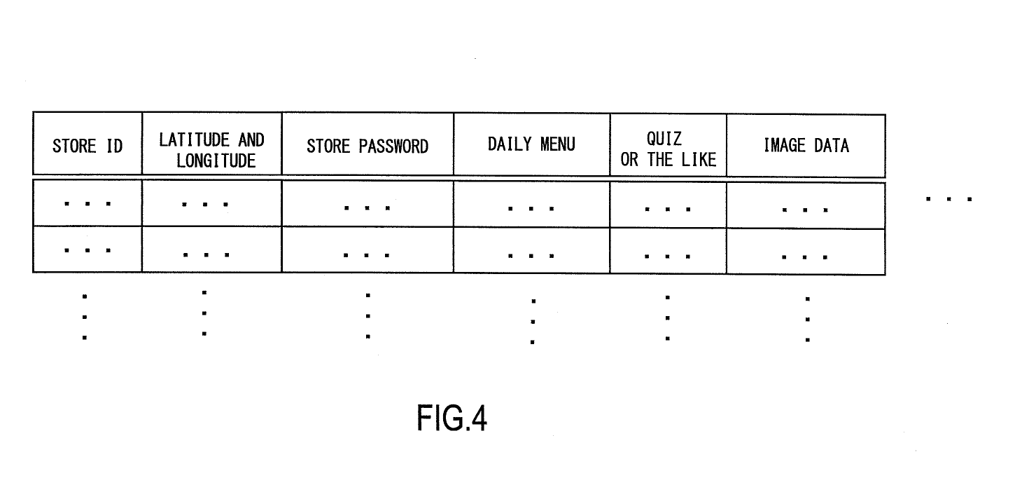

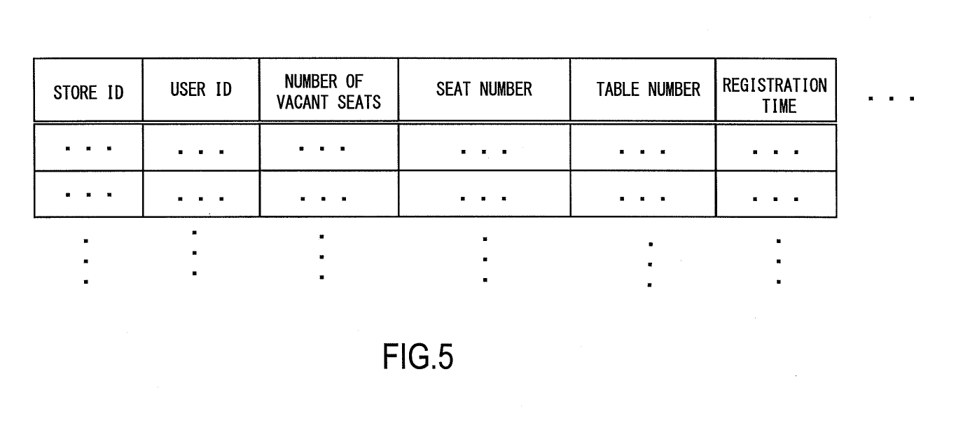

FIG. 2 is a block diagram illustrating an example of a schematic configuration of the information processing server. FIG. 3 is a schematic diagram illustrating an example of data stored in a store database. FIG. 4 is a schematic diagram illustrating an example of data stored in a registration determination database. FIG. 5 is a schematic diagram illustrating an example of data stored in a vacant seat information database.

As illustrated in FIG. 2, the information processing server 10 includes a communication unit 11, a storage unit 12, an input/output interface 13, and a system control unit 14. The system control unit 14 and the input/output interface 13 are connected via a system bus 15.

The communication unit 11 is configured to connect to the network 3 to control the communication state between the mobile terminal device 20 and the terminal device 30.

The storage unit 12 is configured by, for example, a hard disk drive or the like, and stores various programs, such as an operating system and a server program, and the files or the like of a webpage described in a markup language such as HTML or the like. For example, the various programs may be acquired from another server device through the network 3, and may be recorded in a recording medium and read by a drive device.

Moreover, the storage unit 12 constructs therein, a store database 12a (hereinafter referred to as a “store DB 12a”), a membership database 12b (hereinafter referred to as a “membership DB 12b”), a registration determination collation information database 12c (hereinafter referred to as a “registration determination collation information DB 12c) that stores information necessary for determining whether the vacant seat information on stores transmitted from the mobile terminal device 20 is to be registered or not, and a vacant seat information database 12d (hereinafter referred to as a “vacant seat information DB 12d”) that stores the vacant seat information transmitted from the mobile terminal device 20, and the like.

The store database 12a registers therein a store ID (an example of store identification information for identifying stores) and store information such as a store name, a store location, map information, a telephone number, service information such as menus, information on whether or not capable of providing products or services, the genre of dishes or the like, a budget, pictures of store, menu, and the like, the seating capacity in the store, layout information on the layout of seats or tables, the degree of congestion with time zone, and a business day. The layout information includes information on the fixed total number for each table. Such store information can be differentiated for each store by the store ID. As illustrated in FIG. 3, the store ID of each store and the store information are stored in the store DB 12a in association with each other. Incidentally, the layout information includes a seat number for specifying seats, a table number for specifying tables, and the number of persons which can use a table.

The membership DB 12b registers therein a user ID of a user registered as a member (for example, a registrant who registers vacant seat information) and user information, such as a name, an address, a telephone number, an email address, an occupation, a hobby, an available point amount, and a registration history of vacant seat information. Moreover, the membership DB 12b registers therein a user ID, a login ID, and a password necessary when the user of a store registers vacant seat information from the mobile terminal device 20. Here, the login ID and the password are login information used for a login process (user authentication process).

The registration determination collation information DB 12c stores therein registration determination collation information for collating registration determination information transmitted from the mobile terminal device 20 of the registrant in order to determine whether or not to register the vacant seat information. The registration determination collation information is information necessary for determining whether the vacant seat information is vacant seat information of a specific store. Examples of the registration determination collation information include the latitude and longitude indicating the location of a store, a daily menu of each store, a quiz on a store and an answer of the quiz, an interior picture that can specify a store, and a time-dependent store password like a daily store password of each store. As illustrated in FIG. 4, the store ID of a store and the registration determination collation information are stored in advance in the registration determination collation information DB 12c in association with each other. Here, examples of the registration determination information include the latitude and longitude of the mobile terminal device 20, a store's daily menu input by the registrant, a reply to the quiz on a store, image data of a picture of a store's interior, exterior, or the like, and an input store password.

The vacant seat information received from the mobile terminal device 20 is stored in the vacant seat information DB 12d which is an example of a storing means that stores the vacant seat information and the store identification information in association with each other. Examples of the vacant seat information for specifying the number of vacant seats in a store include the number of vacant seats, a vacant seat number, a vacant table number, and the like. Moreover, an occupied seat number and an occupied table number may be used as the vacant seat information. Moreover, captured image data including vacant seats and tables may be used as the vacant seat information in order to specify the number of vacant seats and the vacant seats and tables. In this case, the image data is processed to specify the number of vacant seats and the vacant seats and tables.

As illustrated in FIG. 5, the store ID, the user ID of the registrant, the vacant seat information, and a registration time are stored in the vacant seat information DB 12d in association with each other. The user ID of the registrant who registers the vacant seat information is used for providing the registrant with a privilege, for example, when the vacant seat information is registered, after the vacant seat information is collated, when a user accesses a webpage of the vacant seat information of a specific store, and the like. Here, the privilege provided to the registrant includes a reward such as a coupon of the store and a point that can be used in a matching site.

The input/output interface 13 is configured to perform interfacing processes between the communication unit 11 and the storage unit 12, and the system control unit 14.

The system control unit 14 is configured to include a central processing unit (CPU) 14a, a read only memory (ROM) 14b, a random access memory (RAM) 14c (an example of a storing means), and the like. The system control unit 14 functions as a collating means or the like that collates the vacant seat information and the store information registered by the user with the search condition acquired from the terminal device 30 of a user who visits the store by the CPU 14a reading and executing various programs stored in the ROM 14b and the storage unit 12.

(2.2 Configuration and Function of Mobile Terminal Device 20)

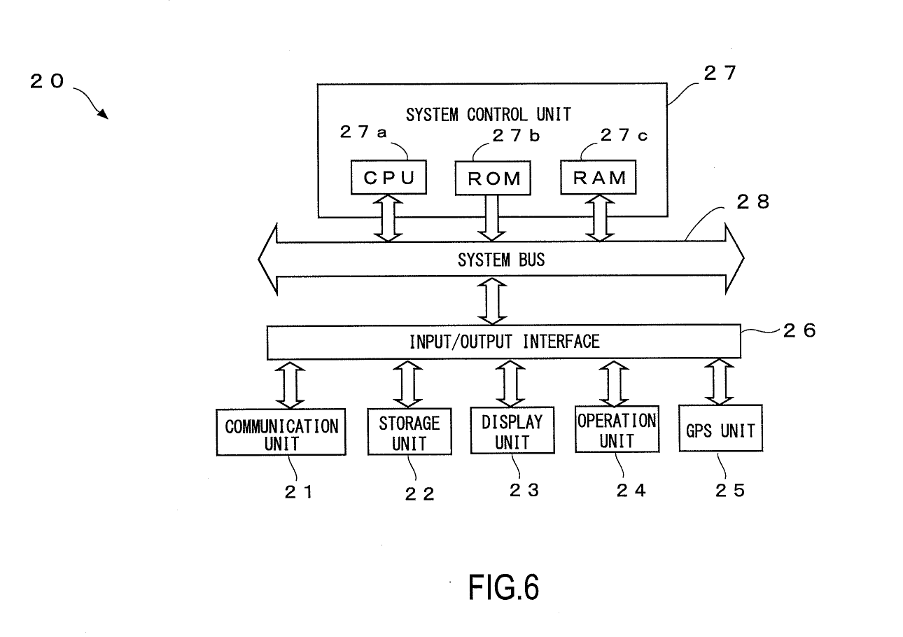

Next, the configuration and function of the mobile terminal device 20 will be described with reference to FIG. 6.

FIG. 6 is a block diagram illustrating an example of a schematic configuration of the mobile terminal device 20.

As illustrated in FIG. 6, the mobile terminal device 20 that functions as a computer is a mobile terminal such as a mobile wireless phone or a tablet terminal including a personal computer and a smartphone and includes a communication unit 21, a storage unit 22, a display unit 23, an operation unit 24, a GPS unit 25, an input/output interface 26, and a system control unit 27. The system control unit 27 and the input/output interface 26 are connected via a system bus 28.

The communication unit 21 controls the communication with the information processing server 10 and the like via the network 3. Incidentally, when the mobile terminal device 20 is a mobile terminal device, the communication unit 21 has a radio communication function in order to connect to a mobile communication network of the network 3.

The storage unit 22 is configured by, for example, a hard disk drive or the like, and stores an operating system, a web browser program, a program for a web browser toolbar, and the like.

The display unit 23 (an example of a displaying means) is configured by, for example, a liquid crystal display device, an electroluminescence (EL) device, or the like.

The operation unit 24 is configured by, for example, a keyboard, a mouse, and the like. The user inputs a reply using the operation unit 24. Incidentally, when the display unit 23 is a touch switch-type display panel like a touch panel, the operation unit 24 acquires the position information of a position of the display unit 23 on which the user touches or the proximity thereof.

The GPS unit 25 has a global positioning system (GPS) sensor and is configured to receive navigation waves from a GPS satellite on a satellite orbit to detect the position, the altitude, and the like of the mobile terminal device 20.

The input/output interface 26 is an interface between the communication unit 21 and the storage unit 22, and the system control unit 27.

The system control unit 27 includes, for example, a CPU 26a, a ROM 26b, and a RAM 26c. The system control unit 27 allows the CPU 26a to read and execute various programs stored in the ROM 26b, the RAM 26c, and the storage unit 22. For example, the system control unit 27 executes a web browser program to function as a web browser.

(2.3 Configuration and Function of Terminal Device 30)

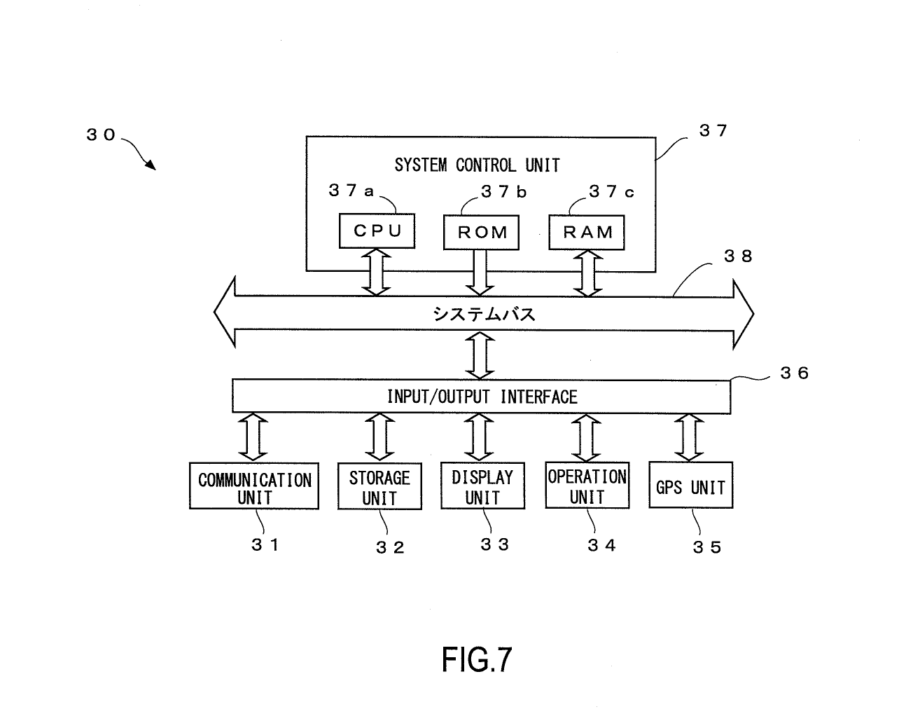

Next, the configuration and function of the terminal device 30 will be described with reference to FIG. 7.

FIG. 7 is a block diagram illustrating an example of a schematic configuration of the terminal device 30.

As illustrated in FIG. 7, the terminal device 30 that functions as a computer is a mobile terminal such as a mobile wireless phone or a tablet terminal including a personal computer and a smartphone like the mobile terminal device 20 and includes a communication unit 31, a storage unit 32, a display unit 33 (an example of a displaying means), an operation unit 34, a GPS unit 35, an input/output interface 36, and a system control unit 37. The system control unit 37 and the input/output interface 36 are connected via a system bus 38. Incidentally, the configuration and function of the terminal device 30 are substantially the same as the configuration and function of the mobile terminal device 20, and the details thereof will not be described. Moreover, the terminal device 30 is not limited to a mobile terminal but may be a desktop personal computer.

[3. Operation of Embodiment of Information Processing System]

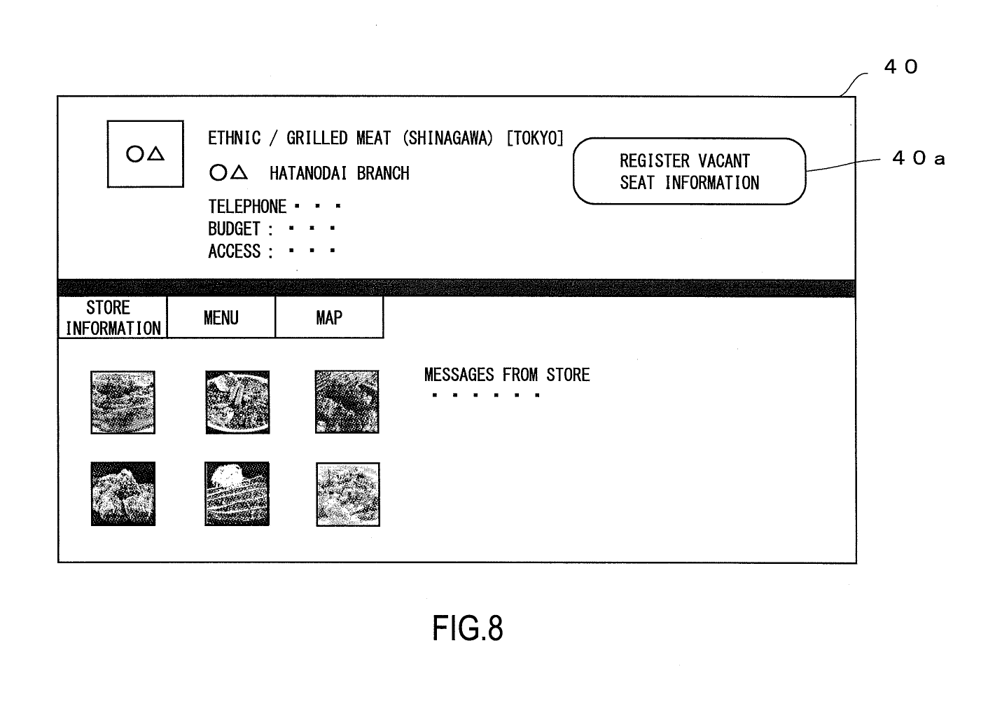

Next, an operation of an embodiment of the information processing system 1 according to an embodiment of the present invention will be described with reference to FIGS. 8 to 12.

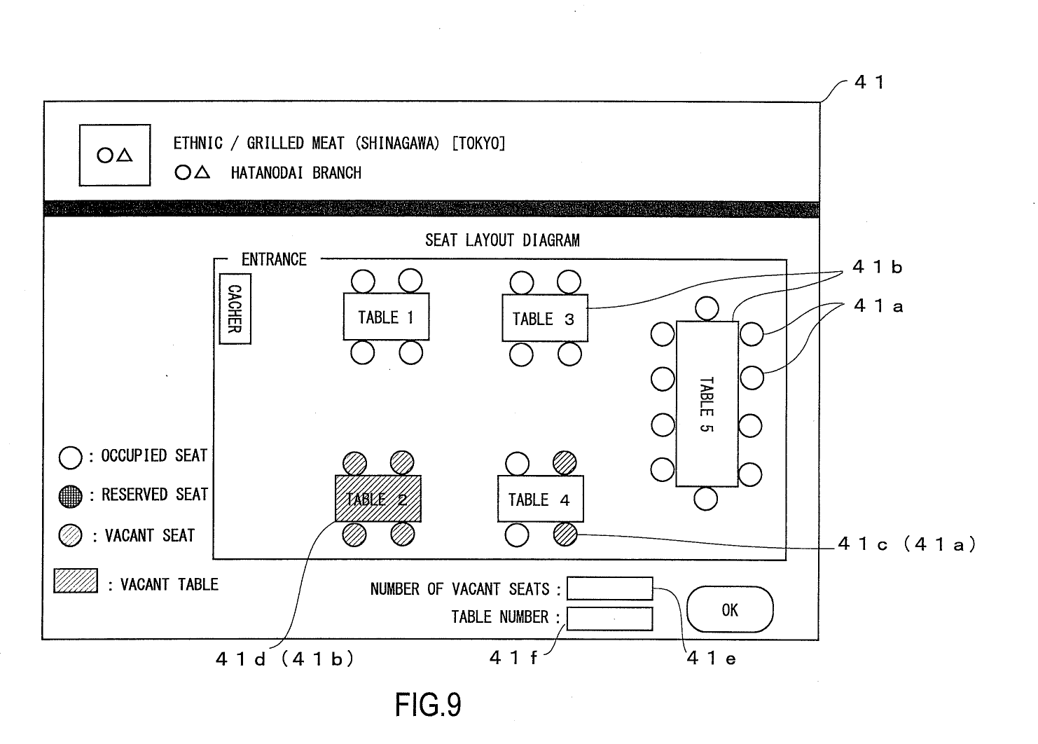

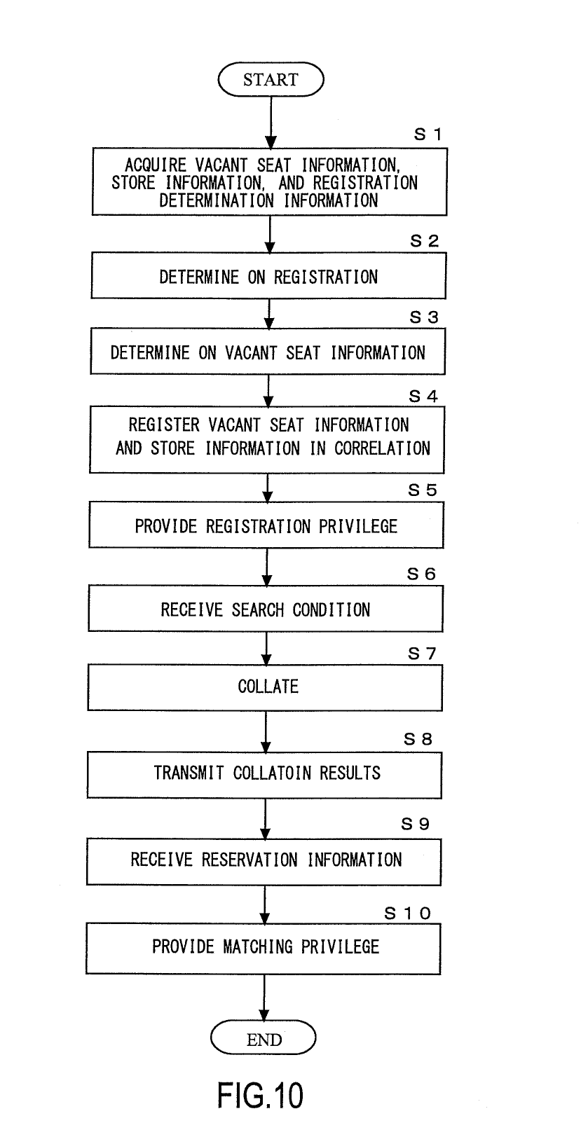

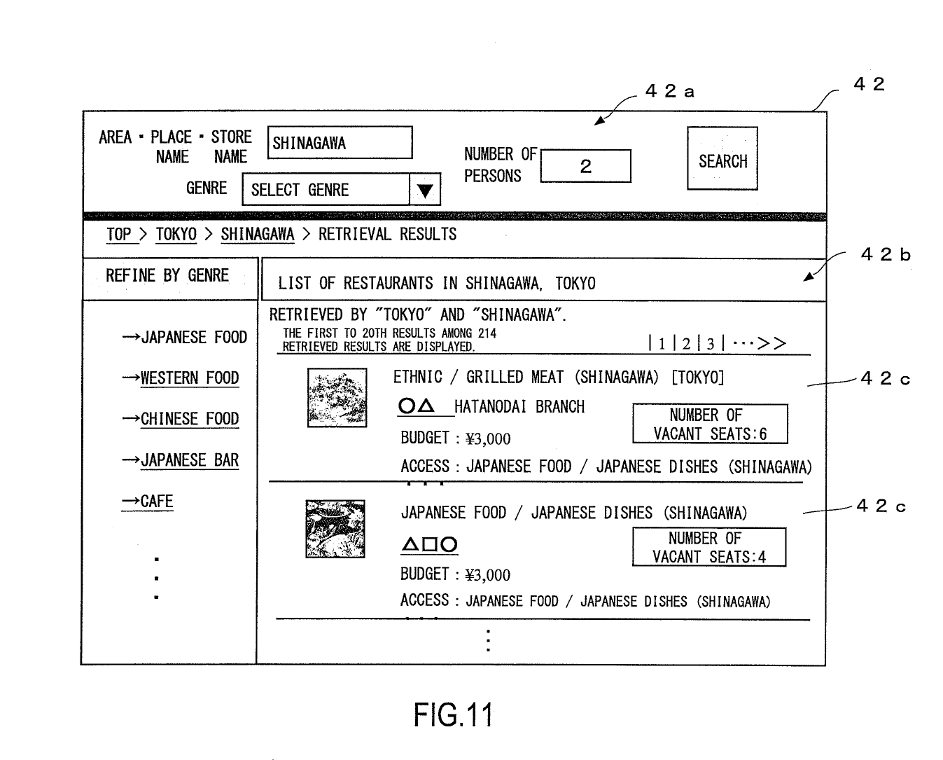

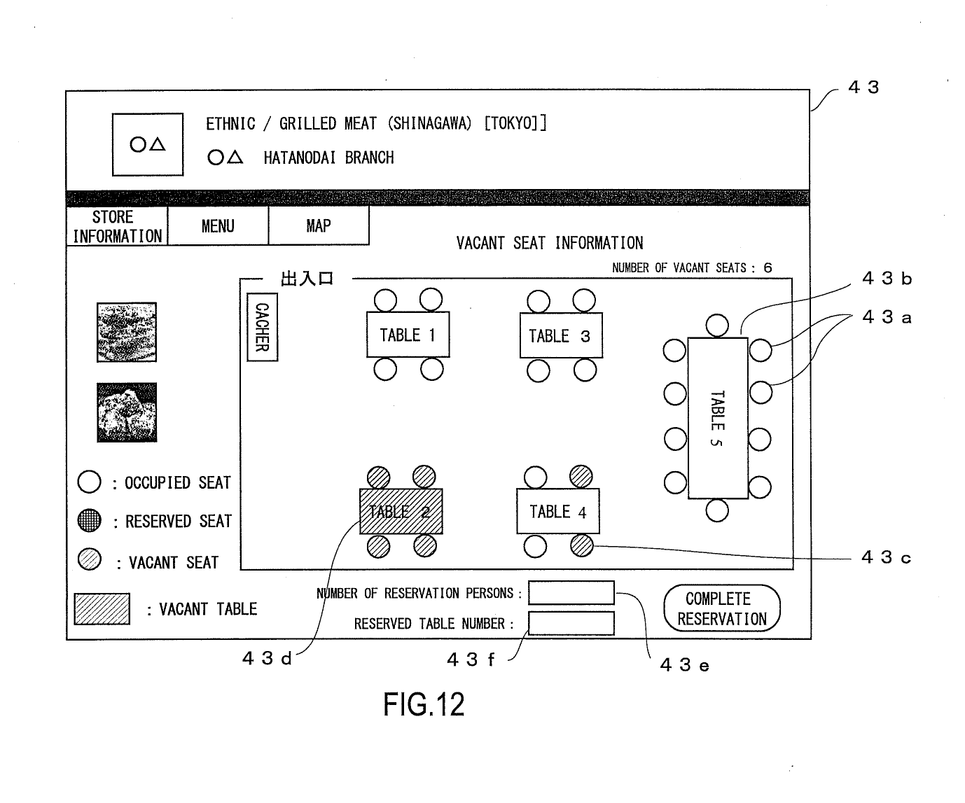

FIG. 8 is a schematic diagram illustrating an example of a screen for registering vacant seat information. FIG. 9 is a schematic diagram illustrating an example of a screen for inputting vacant seat information. FIG. 10 is a flowchart illustrating an example of the operation of the information processing server. FIG. 11 is a schematic diagram illustrating an example of retrieval results obtained by the information processing server. FIG. 12 is a schematic diagram illustrating an example of a screen for displaying vacant seat information.

(3.1 Example of Vacant Seat Information Registering Operation)

First, an example of a vacant seat information registering operation will be described with reference to FIGS. 8 to 10.

It is assumed that a user (registrant) of the mobile terminal device 20 visits a certain store (for example, a restaurant) and uses the store. The registrant accesses a vacant seat information registration site of the information processing server 10 in order to register the vacant seat information of a visiting store. For example, as illustrated in FIG. 8, the mobile terminal device 20 receives information on a webpage 40 of the store and displays the information on the display unit 23. The registrant performs a select operation such as tapping or clicking on a button 40a of the webpage 40 in order to move to a webpage for inputting vacant seat information. Incidentally, the button 40a or the like of the webpage 40 is selected by tapping on the button 40a or the like.

Next, as illustrated in FIG. 9, the mobile terminal device 20 receives information on a webpage 41 for inputting vacant seat information and displays the information on the display unit 23. A seat layout diagram of the store is displayed in the webpage 41, and seats 41a and tables 41b are displayed in the seat layout diagram according to the layout of the store.

The registrant taps on a vacant seat (for example, seat 41c) or a vacant table (for example, table 41d) in the webpage 41 displayed on the display unit 23 of the mobile terminal device 20 to designate a seat or a table. Incidentally, the registrant may designate occupied seats or tables. Moreover, the registrant may input the number of vacant seats in a number-of-vacant-seats field 41e and a table number corresponding to the vacant seat in a table number field 41f. In this manner, the seat or table designated by tapping and the input table number are examples of information on a layout diagram.

Moreover, during registration, the registrant may tap on a seat on which the registrant sits or has sat. Moreover, information on seat or tables of which the vacant seat information has already been input may not be input.

As described above, the number of vacant seats is an example of the vacant seat information. Moreover, examples of the vacant seat information include information on a layout diagram illustrating the layout of at least one of seats and tables in the store, which are displayed on the first terminal device and input by the user of the first terminal device.

When the registrant taps on an OK button, the mobile terminal device 20 transmits the vacant seat information, the store information, and the registration determination information to the information processing server 10. Specifically, the number of tapped seats, the position information of tapped seats, the table numbers corresponding to the tapped seats, the table numbers corresponding to the tapped tables, and the number of vacant seats (for example, the number input in the number-of-vacant-seats field 41e or the number of vacant seats calculated by summing the seating capacity by the table corresponding to the table number and the number of tapped seats) are transmitted as the vacant seat information.

Moreover, the store ID is transmitted as the store information. Incidentally, an ID that can specify the webpage 41 may be transmitted instead of the store ID.

The mobile terminal device 20 transmits the position information of a current position of the mobile terminal device 20, read from the GPS unit 25 to the information processing server 10 as an example of the registration determination information. Incidentally, in the webpage 41, a daily menu of each store, a reply to a quiz on a store, an interior picture that can specify a store, and a time-dependent store password like a daily store password of each store may be transmitted as an example of the registration determination information.

Further, the mobile terminal device 20 transmits a user ID to the information processing server 10 together with the vacant seat information, the store information, and the registration determination information. Incidentally, information that can specify the registrant, like a terminal ID or the like of the mobile terminal device 20 may be transmitted instead of the user ID of the registrant.

As illustrated in FIG. 10, the information processing server 10 acquires the vacant seat information, the store information, and the registration determination information (step S1). Specifically, the system control unit 14 of the information processing server 10 acquires the vacant seat information, the store information, and the registration determination information from the mobile terminal device 20. Moreover, the system control unit 14 also acquires the user ID from the mobile terminal device 20. Further, the system control unit 14 stores the acquisition time at which the these items of information was acquire in the RAM 14c or the like.

In this manner, the information processing server 10 functions as an example of an information acquiring means that acquires the vacant seat information for specifying the number of vacant seats in a store and the store identification information for identifying the store from the mobile terminal device of the user of the store. Moreover, the information processing server 10 functions as an example of an information acquiring means that acquires the registration determination information for determining whether the vacant seat information is to be registered in the storing means from the mobile terminal device.

Next, the information processing server 10 performs a process of determining whether the registration of the received vacant seat information is to be received (step S2). This process is an example of a process of checking the validity of the vacant seat information.

Specifically, the system control unit 14 obtains the position information (an example of the registration determination collation information) of the store, such as the latitude and longitude of the store, from the received store ID by referring to the registration determination collation information DB 12c.

Next, the system control unit 14 compares the position information of the store with the position information (an example of the registration determination information) of the current position of the mobile terminal device 20 to calculate the distance between the store and the current position of the mobile terminal device 20. For example, the system control unit 14 calculates a straight-line distance from the position information of the store and the current position of the mobile terminal device 20 or a road distance from map information.

Next, the system control unit 14 calculates a time (an example of a store use-related time related to the use of a store by the user of the mobile terminal device 20) in which the mobile terminal device 20 is away from the store by dividing the distance by an average walking speed or the like. In this manner, if the time is within a predetermined period after the user leaves the store, the registration is received unless the user is not in the store.

In this manner, the information processing server 10 functions as a registration reception determining means that determines whether the registration of the vacant seat information is to be received based on the distance between the mobile terminal device and the store. Moreover, the information processing server 10 functions as an example of a store use-related time calculation means that calculates the store use-related time related to the use of the store by the user of the mobile terminal device from the registration determination information.

Next, the system control unit 14 determines that the registration of the vacant seat information is to be received as the vacant seat information that is accurate in terms of time, from the store if the time leaving from the store is within 30 minutes, for example, which is an example of the predetermined time, and determines that the registration of the vacant seat information is not to be received if the time leaving from the store is not within 30 minutes. Incidentally, the system control unit 14 may receive the registration of the vacant seat information if the current position of the mobile terminal device 20 is within a predetermined range from the store.

Incidentally, the system control unit 14 may determine that the registration of the vacant seat information is to be received as the accurate vacant seat information from the store, by comparing the information (an example of the registration determination information) on the daily menu of each store, received from the mobile terminal device 20 with the information (an example of the registration determination collation information) of the daily menu, stored in the registration determination collation information DB 12c with reference to the registration determination collation information DB 12c using the store ID, when the two items of information are identical. Moreover, the system control unit 14 may determine that the registration of the vacant seat information is to be received as the accurate vacant seat information from the store, by comparing the information (an example of the registration determination information) on the reply to a quiz on the store, received from the mobile terminal device 20 with the information (an example of the registration determination collation information) on the reply to a quiz on the store, stored in the registration determination collation information DB 12c with reference to the registration determination collation information DB 12c using the store ID, when the two items of information are identical. Further, the system control unit 14 may determine that the registration of the vacant seat information is to be received as the accurate vacant seat information from the store, when by comparing the information (an example of the registration determination information) on a daily store password of each store, received from the mobile terminal device 20 with the information (an example of the registration determination collation information) on the daily store password of each store, stored in the registration determination collation information DB 12c with reference to the registration determination collation information DB 12c using the store ID, when the two items of information are identical.

Further, the system control unit 14 may determine that the registration of the vacant seat information is to be received as the accurate vacant seat information from the store, by comparing the information (an example of the registration determination information) on an interior picture that can specify the store, received from the mobile terminal device 20 with the image data (an example of the registration determination collation information) stored in the registration determination collation information DB 12c using image processing with reference to the registration determination collation information DB 12c using the store ID, when the two items of information or data are similar or identical. Furthermore, the system control unit 14 may determine that the registration of the vacant seat information is to be received as the vacant seat information that is accurate in terms of time, from the store, when the difference between the store time and the acquisition time is within a predetermined time by subtracting the time in which the mobile terminal device 20 is away from the store from the acquisition time as an example of the store use-related time, calculating a store time in which the user of the mobile terminal device 20 was in the store.

Moreover, in the case that the table number and the number of vacant seats are included in the vacant seat information, the system control unit 14 may determine that the registration of the vacant seat information is to be received, when there is not inconsistency by obtaining the number of persons who can sit in a table from the table number with reference to the store DB 12a, and determining whether there is inconsistency between the obtained number of persons and the number of vacant seats (for example, whether the number of vacant seats is larger than the number of persons who can sit at the table). Moreover, it may be determined that the registration of the vacant seat information is to be received, by comparing a trend of a past vacant seat state with the number of vacant seats, unless there is a large difference therebetween. Further, the system control unit 14 may determine that the input content is false and the registration of the vacant seat information is not to be received when the input number of vacant seats or the number of vacant seats calculated from the table number is larger than the maximum seating capacity in the store with reference to the store DB 12a.

Moreover, whether the registration of the vacant seat information is to be received may be determined according to the credibility by setting a credibility (for example, a score or the like) to each registrant. For example, a determination degree of the degree of difference between the trend of the past vacant seat state and the number of vacant seats may be changed according to the credibility. Moreover, in order to obtain the determination of a third party, a person who visits the store, such as the user of the terminal device 30 other than the registrant of the mobile terminal device 20 may determine the validity of the vacant seat information to score the credibility of the registrant.

Next, the system control unit 14 determines whether the same registrant has registered the vacant seat information for a predetermined number of times within a predetermined time in the same store and determines whether the vacant seat information is to be received or not with reference to the vacant seat information DB 12d using the user ID and the store ID. For example, in the case that the same registrant has registered (or has transmitted the vacant seat information for registration as a registration action) the vacant seat information once within a first predetermined time (for example, 30 minutes) in the same store, it is determined that the registration is not to be received. Incidentally, it may be determined whether the same registrant has performed a registration action for a predetermined number of times within a predetermined time regardless of the store. In this manner, the registration may be restricted. Moreover, when the registration action is received from the same mobile terminal device 20 within a predetermined time, if the items of vacant seat information are different, the vacant seat information is not counted in.

In this manner, the information processing server 10 functions as an example of a registration reception determining means that determines whether the registration of the vacant seat information in the storing means is to be received according to the registration determination information acquired by the information acquiring means. Moreover, the information processing server 10 functions as an example of a registration reception determining means that determines that the registration of the vacant seat information is to be received when the store use-related time calculated by the store use-related time calculation means is within a predetermined time. Further, the information processing server 10 functions as an example of the registration reception determining means that determines that the registration of the vacant seat information is not to be received when the vacant seat information of the same content is acquired from the mobile terminal device within a first predetermined time.

Next, the information processing server 10 performs a vacant seat information determination process (step S3). This process is a process of distinguishing the input vacant seat information and the vacant seat information registered in advance.

Specifically, the system control unit 14 refers to the vacant seat information DB 12d using the store ID to determine whether items of vacant seat information registered within a predetermined time (an example of a second predetermined time) from a plurality of mobile terminal devices 20 in the same store are information on the same vacant seat. For example, if the layout information is known, the table number is included in the vacant seat information, and the table numbers are the same, the items of vacant seat information are determined to be of the same content. Incidentally, in addition to the table number, if the seat numbers are the same, the numbers of vacant seat are the same, or the combinations thereof are the same, the items of vacant seat information may be determined to be of the same content.

Moreover, the system control unit 14 may determine whether items of image data (an example of the registration determination information) obtained by capturing vacant seats, transmitted from the respective mobile terminal devices 20 are identical or similar and determine that the items of vacant seat information are of the same content if the items of image data are identical or similar. In this case, the items of vacant seat information may be determined to be of the same content even when the numbers of vacant seats are different.

Moreover, as for seats and tables of which the vacant seat information is already input, the process of step S3 may not be performed in order to prevent redundant registration of the vacant seat information. Moreover, when there are identical or similar items of vacant seat information, the process of step S3 may not be performed and the identical or similar items of vacant seat information may be registered so that the user of the terminal device 30 select the vacant seat information.

Moreover, when items of information “four seats are vacant,” “four seats are vacant,” and “six seats are vacant” are input from three registrants, the registration of the information “six seats are vacant” may be deleted by the majority rule even after the registration. Moreover, in this case, when it is determined in step S3 that three items of vacant seat information are different, it may be determined that “fourteen seats are vacant” in the store by summing the items of information. Moreover, as in step S2, the vacant seat information of the registrant having the highest credibility value among the three registrants may be adopted based on the credibility of each registrant. Further, as in step S2, the vacant seat information that seems most reliable from the trend of the past vacant seat state may be selected.

In this manner, the information processing server 10 functions as an example of a vacant seat information determining means that determines whether the items of vacant seat information are information on the same vacant seat when the information acquiring means acquires the items of vacant seat information of the same content within a second predetermined time from the mobile terminal devices of a plurality of store users.

Next, the information processing server 10 registers the vacant seat information and the store information in association with each other (step S4). When it is determined in step S2 that the registration is to be received and it is determined in step S3 that the plurality of items of input vacant seat information is not identical, as illustrated in FIG. 5, the system control unit 14 stores the respective items of vacant seat information (for example, the number of vacant seats, the seat number, the table number, and the like) in association with the store ID of the store information, the user ID, and a registration time such as the time when the vacant seat information was received.

In this manner, the information processing server 10 functions as an example of a registering means that registers the vacant seat information in the storing means in association with the store identification information. Moreover, the information processing server 10 functions as an example of the registering means that registers the vacant seat information in association with the store identification information when the registration reception determining means determines that the registration is to be received.

Next, the information processing server 10 performs a process of providing a registration privilege (step S5). Specifically, the system control unit 14 provides a registration privilege by increasing the point amount in the membership DB 12b based on the user ID. More specifically, the system control unit 14 determines a privilege provided to the registrant according to the registration time when items of vacant seat information of the same content are registered. For example, when a plurality of registrants (store users) is present, the later the registration time is, the smaller the registration point becomes. Alternatively, the registration point may be provided only to the earliest registrant.

Incidentally, the point amount of the registration privilege may be smaller than the point amount of a matching privilege described later. Moreover, the point amount of the registration privilege may be changed based on the trend information of the past vacant seat state. As an example of increasing the value of the provided privilege in a time zone when many persons actually use the store, the point amount provided may be increased when the vacant seat information is registered in a time zone when there are small vacant seats, for example.

In this manner, the information processing server 10 functions as an example of a registration privilege determining means that determines a privilege provided to the user of the mobile terminal device when the registration reception determining means determines that the registration of the vacant seat information is to be received. Moreover, the information processing server 10 functions as an example of the registration privilege determining means that changes the value of the provided privilege according to the time zone. Moreover, the information processing server 10 functions as an example of the registration privilege determining means that increase the value of the provided privilege in a time zone when many persons actually use the store. Further, the information processing server 10 functions as an example of the registration privilege determining means that determines the privilege according to the registration time of the vacant seat information when the information acquiring means acquires the items of vacant seat information of the same content from the plurality of mobile terminal devices in a second predetermined time. Further, the information processing server 10 functions as an example of the registration privilege determining means that determines the privilege provided to a plurality of store users according to the registration time of the vacant seat information when the vacant seat information determining means determines that the items of vacant seat information are information on the same vacant seat.

(3.2 Example of Search Condition Collating Operation)

Next, an example of a search condition collating operation will be described with reference to FIGS. 10, 11, and 12.

It is assumed that the user of the terminal device 30 looks for a store in order to use the store. In order to search for a store, the user of the terminal device 30 accesses a vacant seat information registration site of the information processing server 10. For example, as illustrated in FIG. 11, the terminal device 30 receives information on a webpage 42 for retrieving a store and displays the information on the display unit 33. When the user of the terminal device 30 inputs a search keyword such as a place name, a store name, a genre, and the number of members in a search condition field 42a and taps on a search button, the search condition including the number of members is transmitted from the terminal device 30 to the information processing server 10.

As illustrated in FIG. 10, the information processing server 10 receives the search condition (step S6). Specifically, the system control unit 14 receives the search condition from the terminal device 30.

In this manner, the information processing server 10 functions as an example of a search condition acquiring means that acquires the search condition including the number of members from the terminal device of a user who looks for a target store to use.

Next, the information processing server 10 performs collation (step S7). Specifically, the system control unit 14 collates the vacant seat information and the store information with the search condition using a retrieving function with reference to the store DB 12a and the vacant seat information DB 12d and obtains information on the retrieval results (collation results) that meet the search condition.

In this manner, the information processing server 10 functions as an example of a collating means that collates the vacant seat information and the store identification information registered in the storing means with the search condition acquired by the search condition acquiring means.

Next, the information processing server 10 transmits the information on the collation results (step S8). As illustrated in FIG. 11, the information on the collation results 42b is transmitted to the terminal device 30.

In this manner, the information processing server 10 functions as an example of a collation result transmitting means that transmits the information on the collation results obtained by the collating means to the terminal device.

Next, as illustrated in FIG. 11, the terminal device 30 displays the webpage 42 including the collation results 42b on the display unit 33. The store information 42c of each store is displayed in the webpage 42. The number of vacant seats in the vacant seat information is also displayed in the store information 42c. Incidentally, in the webpage 42, the store having a large number of vacant seats is preferentially displayed as the collation results. In this case, it is possible to obviate a state where “a user has visited a store but no seat was vacant”.

When the user of the terminal device 30 taps on the store information 42c, a webpage for inputting reservation information of the selected store is displayed.

As illustrated in FIG. 12, the terminal device 30 receives the information on a webpage 43 for inputting the reservation information from the information processing server 10 and displays the information on the display unit 33. In the webpage 43, a seat layout diagram indicating vacant seats and a vacant seat state is displayed as the vacant seat information. In the seat layout diagram, seats (occupied seats) 43a that are occupied, occupied tables 43b, vacant seats 43c, and vacant tables 43d are displayed in accordance with the layout of the store. Moreover, the number of vacant seats is also displayed in the webpage 43 as the vacant seat information.

The user of the terminal device 30 taps on a vacant seat (for example, the seat 43c) or a vacant table (for example, the table 43d) in the webpage 43 displayed on the display unit 33 of the terminal device 30 to designate a seat or a table to be reserved. Incidentally, the user of the terminal device 30 may input the number of reservation persons in a number-of-reservation-persons field 43e and a reservation table number in a table number field 43f. Moreover, as for seats and tables that are already occupied, no input may be received.

When the user of the terminal device 30 taps on a reservation completion button, the terminal device 30 transmits the reservation information to the information processing server 10. Specifically, the number of tapped and reserved seats, the position information of the tapped seats, the table number of the tapped seats, the table number of the tapped table, and the number of reservation persons (for example, the number input in the number-of-reservation-persons field 43e or the number of reservation persons calculated by summing the seating capacity by the table corresponding to the table number and the number of tapped seats) are transmitted as the reservation information.

Next, the information processing server 10 receives the reservation information from the terminal device 30 (step S9). Then, the information processing server 10 decreases the number in the “number of vacant seats” in the webpage 42 by the number of reservation persons and changes the color or the like of the reserved seats and table in the webpage 43 to the color of a reserved seat.

Next, the information processing server 10 performs a process of providing a matching privilege (step S10). When the reservation information is received from the terminal device 30 and the reservation is completed, the system control unit 14 provides a matching privilege by increasing the point amount in the membership DB 12b based on the user ID. More specifically, when the vacant seat information of the same content is registered, the system control unit 14 determines the matching privilege provided to the registrant according to the registration time. For example, the later the registration time is, the smaller the matching point becomes. Alternatively, the matching point may be provided only to the earliest registrant.

Incidentally, after the search condition collating operation of step S7 is performed, when in step S8, the retrieval results (the webpage 42) on a plurality of stores are displayed and the information on the webpage 43 for inputting the reservation information of the store selected by the user of the terminal device 30 is displayed on the terminal device 30 (an example of when a webpage of the vacant seat information of a specific store is accessed), the information processing server 10 may provide the matching privilege. That is, the information processing server 10 may provide the matching privilege when a state where the user of the terminal device 30 can browse the vacant seat information of the specific store is created. Moreover, an example of when the webpage of the vacant seat information of the specific store is accessed may include when the information processing server 10 receives a request to display the webpage 43 or transmits the information on the webpage 43. Further, the process of providing the registration privilege may be omitted, and the privilege may be provided only when the matching is satisfied (for example, when the webpage indicating the vacant seat information of the specific store is accessed or a reservation is made after the search conditions are collated).

Moreover, the point amount of the matching privilege may be changed based on the trend information of the past vacant seat state. As an example of increasing the value of the provided privilege in a time zone when many persons actually use the store, the provided point amount may be increased when the vacant seat information is registered in a time zone when there is a small number of vacant seats.

In this manner, the information processing server 10 functions as an example of a matching privilege determining means that determines a privilege provided to the user of the mobile terminal device when the terminal device accesses a webpage showing the vacant seat information of a specific store, acquired from the mobile terminal device after the collating means performs the collation operation. Moreover, the information processing server 10 functions as an example of the matching privilege determining means that changes the value of the provided privilege according to the time zone. Further, the information processing server 10 functions as an example of the matching privilege determining means that increases the value of the provided privilege in a time zone when many persons actually use the store. Further, the information processing server 10 functions as an example of the matching privilege determining means that determines the privilege based on the registration time of the vacant seat information when the information acquiring means acquires items of vacant seat information of the same content from the plurality of mobile terminal devices in the second predetermined time. Further, the information processing server 10 functions as an example of the matching privilege determining means that determines the privilege provided to the plurality of store users according to the registration time of the vacant seat information when the vacant seat information determining means determines that the items of vacant seat information are information on the same vacant seat.

Incidentally, when the reservation information is received from the terminal device 30 and a reservation can be made, the information processing server 10 transmits information to the terminal device 30 indicating that the reservation has been received and completed. Moreover, when the reservation information is received from the terminal device 30 and a reservation can be made, the information processing server 10 transmits information to the mobile terminal device 20 that has registered the vacant seat information, indicating that the reservation has been received and completed, based on the user ID of the registrant who has registered the vacant seat information.

The information indicating that the reservation has been received and completed may be transmitted when the payment by credit cards or the like is completed or when money is withdrawn from a bank account of credit cards or the like without limiting to when the reservation information is received or completed. Incidentally, when a reservation is received via a telephone call, a one-time reservation telephone number may be displayed in the webpage 42, and the reservation information may be received from a store terminal linked to the telephone number based on the one-time reservation telephone number.

According to the present embodiment, by collating the vacant seat information and the store identification information registered from the mobile terminal device 20 of the user of the store with the search condition acquired from the terminal device 30 of the user who looks for a target store to use, it is possible to reduce the time and labor of a store's staff required for the vacant seat registration operation. Moreover, the vacant seat information can be automatically matched by users without via the store. Moreover, since the vacant seat information can be automatically matched by the users without via the store, it is possible to eliminate the time and labor of the store's staff required for the operation of registering the vacant seat information.

The registration determination information for determining whether the vacant seat information is to be registered in the storing means is acquired from the mobile terminal device 20, and it is determined whether the registration of the vacant seat information is to be received based the acquired registration determination information. In the case that it is determined that the registration is to be received, the registration determination information is acquired from the mobile terminal device 20 when the vacant seat information and the store information are registered in the vacant seat information DB 12d in association with each other. It is determined whether the information is to be registered based on the registration determination information. The information is registered when it is determined that the information is to be registered. Therefore, it is possible to eliminate the registration of vacant seat information that is not suitable for registration.

Moreover, in the case that it is determined whether the registration of the vacant seat information is to be received based on the distance between the mobile terminal device 20 and the store, due to the basis of the distance between the mobile terminal device 20 and the store it is possible to eliminate the registration of the vacant seat information that is not suitable for registration for example because the mobile terminal device is away from the store.

In the case that the store use-related time related to the use of the store by the user of the mobile terminal device 20 is calculated from the registration determination information, and the registration of the vacant seat information is received when the store use-related time is within a predetermined time, it is possible to allow a wide range of vacant seat information to be registered and to provide rich vacant seat information by limiting the store use-related time to the predetermined time. Moreover, it is possible to eliminate the registration of vacant seat information that is not suitable for registration which is not registered within the predetermined time.

In the case that the registration of the vacant seat information is not received when the vacant seat information of the same content is acquired from the mobile terminal device 20 within the first predetermined time, it is possible to prevent unnecessary registration of the redundant vacant seat information from the same mobile terminal device 20. Moreover, it is possible to prevent an unnecessary privilege from being provided.

In the case that the privilege provided to the registrant is determined when the terminal device 30 accesses the webpage showing the vacant seat information of the specific store after the search conditions are collated, it is possible to provide an incentive to register the vacant seat information.

In the case that the privilege provided to the registrant is determined when it is determined that the registration of the vacant seat information is to be received, it is possible to provide an incentive to register the vacant seat information by providing the privilege to the registrant.

In the case that the value of the provided privilege is changed according to the time zone, it is possible to increase the incentive to register the vacant seat information, by increasing the provided privilege in a time zone when the user of the terminal device 30 wants to have the information.

In the case that the value of the provided privilege is increased in a time zone when many persons actually use the store, for example, since the information when many persons actually use the store and the store is congested is information that the user of the terminal device wants to have, it is possible to increase the incentive for the registration, by increasing the value of the provided privilege in a time zone when the store is congested.

In the case that the privilege is determined according to the registration time of the vacant seat information when the vacant seat information of the same content is acquired from a plurality of mobile terminal devices 20 within the second predetermined time, by increasing the value of the privilege for the earliest registration, for example, it is possible to provide an incentive to register the vacant seat information of the store as early as possible and to collect relatively new information.

In the case that it is determined whether the vacant seat information is information on the same vacant seat when the vacant seat information of the same content is acquired from the plurality of mobile terminal devices 20 within the second predetermined time, it is determine that the vacant seat information is information on the same vacant seat, and the privilege provided to the plurality of store users is determined according to the registration time of the vacant seat information, for example, by increasing the value of the privilege for the early registration, it is possible to provide the incentive to register the vacant seat information of the same content as early as possible and to collect relatively new information. Moreover, in the case that the privilege is provided to the earliest registrant, it is possible to increase the incentive to register the vacant seat information as early as possible in order to obtain the privilege. Moreover, in the case that the value of the privilege decreases gradually with the registration time, it is possible to provide the incentive to register the vacant seat information although it is later than the other.

In the case that the vacant seat information is the number of vacant seats, it is possible to know the number of vacant seats in the store and to provide the user of the terminal device 30 with the information on the number of vacant seats in the store.

In the case that the vacant seat information is information on a layout diagram indicating the layout of at least one of the seats and tables of the store, displayed on the mobile terminal device 20 and acquired by the input of the registrant, it becomes easy to specify the positions of the seats or tables by the layout diagram and to input the vacant seat information. With the layout diagram, it is possible to know the position of the vacant seat and to input the accurate vacant seat information.

Incidentally, although the mobile terminal device 20 and the terminal device 30 are distinguished from each other for the sake of convenience, the user of the mobile terminal device 20 may retrieve the vacant seat information using the mobile terminal device 20 similarly to the terminal device 30 and the user of the terminal device 30 may register the vacant seat information using the terminal device 30 similarly to the mobile terminal device 20.

Moreover, a user who looks for a store such as a restaurant may register in advance conditions of desired stores and an email address of a destination in a matching site of the information processing server 10 so that the store information meeting the conditions may be automatically transmitted to the email address of the user who looks for the store.

The store is not limited to the restaurant. For example, the store may be a beauty salon and may be a store which has been managed manually.

The present invention is not limited to the respective embodiments. The respective embodiments are examples and all inventions having substantially the same configuration as that of the technical ideas described in claims of the present invention and achieving similar operational effects are included in the technical scope of the present invention.

### EXPLANATION OF REFERENCE NUMERALS

1: Information processing system
10: Information processing device
12a: Store DB
12c: Registration determination collation information DB
12d: Vacant seat information DB (Storing means)
20: Mobile terminal device
30: Terminal device

1-14. (canceled)

15. An information processing device comprising:
at least one memory operable to store program code;
at least one processor operable to read said program code and operate as instructed by said program code, said program code including:
information acquiring code that acquires vacant seat information for specifying the number of vacant seats in a store and store identification information for identifying the store from a mobile terminal device of a user of the store; and
registering code that registers the vacant seat information in a storage in correlation with the store identification information, wherein
the information acquiring code acquires registration determination information for determining whether the vacant seat information is to be registered in the storage from the mobile terminal device, and
when the registration determination information acquired by the information acquiring code satisfies a registration reception condition for receiving the registration of the vacant seat information in the storage, the registering code registers the vacant seat information in association with the store identification information.

16. The information processing device according to claim 15, wherein
the registration determination information is position information of the mobile terminal device, and the registration reception condition is a condition based on a distance from the store.

17. The information processing device according to claim 15, wherein
when the vacant seat information of the same content is acquired from the mobile terminal device within a first predetermined time, the registration code does not receive the registration of the vacant seat information.

18. The information processing device according to claim 16, wherein
when the vacant seat information of the same content is acquired from the mobile terminal device within a first predetermined time, the registration code does not receive the registration of the vacant seat information.

19. The information processing device according to claim 15, further comprising:
registration privilege determining code that determines a privilege provided to the user of the mobile terminal device when the registration code receives the registration of the vacant seat information.

20. The information processing device according to claim 19, wherein
the value of the provided privilege is changed according to a time zone.

21. The information processing device according to claim 20, wherein
the value of the provided privilege is increased in a time zone when many persons actually use the store.

22. The information processing device according to claim 19, wherein
when the information acquiring code acquires the vacant seat information of the same content from the mobile terminal devices of a plurality of store users within a second predetermined time, the privilege is determined according to the registration time of the vacant seat information.

23. The information processing device according to claim 22, further comprising:
vacant seat information determining code that determines whether the vacant seat information is information on the same vacant seat when the information acquiring code acquires the vacant seat information of the same content from the mobile terminal devices of the plurality of store users within the second predetermined time, wherein
when the vacant seat information determining code determines that the vacant seat information is information on the same vacant seat, the privilege provided to the plurality of store users is determined according to the registration time of the vacant seat information.

24. The information processing device according to claim 15, wherein
the vacant seat information is the number of vacant seats.

25. The information processing device according to claim 15, wherein
the vacant seat information is information on a layout diagram indicating a layout of at least one of seats and tables in the store, which is displayed on the mobile terminal device and input by the user of the mobile terminal device.

26. An information processing device comprising:
at least one memory operable to store program code;
at least one processor operable to read said program code and operate as instructed by said program code, said program code including:
information acquiring code that acquires vacant seat information for specifying the number of vacant seats in a store and store identification information for identifying the store from a mobile terminal device of a user of the store;
registering code that registers the vacant seat information in a storage in association with the store identification information;
search condition acquiring code that acquires a search condition including the number of members from a terminal device of a user who looks for a target store to use;
collating code that collates the vacant seat information and the store identification information registered in the storage with the search condition acquired by the search condition acquiring code;
collation result transmitting code that causes said information processing device to transmit collation results obtained by the collating code to the terminal device; and
matching privilege determining code that determines a privilege provided to the user of the mobile terminal device when the terminal device accesses a webpage showing the vacant seat information of a specific store, acquired from the mobile terminal device after the collating code performs the collating.

27. The information processing device according to claim 26, wherein
the value of the provided privilege is changed according to a time zone.

28. The information processing device according to claim 27, wherein
the value of the provided privilege is increased in a time zone when many persons actually use the store.

29. The information processing device according to claim 26, wherein
when the information acquiring code acquires the vacant seat information of the same content from the mobile terminal devices of a plurality of store users within a second predetermined time, the privilege is determined according to the registration time of the vacant seat information.

30. The information processing device according to claim 29, further comprising:
vacant seat information determining code that determines whether the vacant seat information is information on the same vacant seat when the information acquiring code acquires the vacant seat information of the same content from the mobile terminal devices of the plurality of store users within the second predetermined time, wherein
when the vacant seat information determining code determines that the vacant seat information is information on the same vacant seat, the privilege provided to the plurality of store users is determined according to the registration time of the vacant seat information.

31. The information processing device according claim 26, wherein
the vacant seat information is the number of vacant seats.

32. The information processing device according to 26, wherein
the vacant seat information is information on a layout diagram indicating a layout of at least one of seats and tables in the store, which is displayed on the mobile terminal device and input by the user of the mobile terminal device.

33. An information processing method of an information processing device including at least one processor that performs information processing, said at least one processor:
acquiring vacant seat information for specifying the number of vacant seats in a store and store identification information for identifying the store from a mobile terminal device of a user of the store; and
registering the vacant seat information in a storage in association with the store identification information, wherein
said acquiring includes acquires registration determination information for determining whether the vacant seat information is to be registered in the storage from the mobile terminal device, and
when the registration determination information acquired satisfies a registration reception condition for receiving the registration of the vacant seat information in the storage, the vacant seat information is registered in association with the store identification information.

34. An information processing method of an information processing device including at least one processor that performs information processing, said at least one processor:
acquiring vacant seat information for specifying the number of vacant seats in a store and store identification information for identifying the store from a mobile terminal device of a user of the store;
registering the vacant seat information in a storage in association with the store identification information;
acquiring a search condition including the number of members from a terminal device of a user who looks for a target store to use;
collating the vacant seat information and the store identification information registered in the storage with the search condition acquired;
transmitting collation results obtained to the terminal device; and
determining a privilege provided to the user of the mobile terminal device when the terminal device accesses a webpage showing the vacant seat information of a specific store, acquired from the mobile terminal device after the collating.
